(19) United States
(12) Patent Application Publication
(10) Pub. No.: US 2014/0295244 A1
(43) Pub. Date: Oct. 2, 2014

(54) PRINTED FLEXIBLE BATTERY

(71) Applicant: Research Foundation of the City University of New York, New York, NY (US)

(72) Inventors: Abhinav Gaikwad, New York, NY (US); Daniel Steingart, Princeton, NJ (US)

(73) Assignee: Research Foundation of the City University of New York, New York, NY (US)

(21) Appl. No.: 14/230,131

(22) Filed: Mar. 31, 2014

Related U.S. Application Data
(60) Provisional application No. 61/806,533, filed on Mar. 29, 2013.

(51) Int. Cl. H01M 6/18; H01M 6/22; H01M 10/0585; H01M 6/40; H01M 10/04

(52) U.S. Cl. CPC H01M 6/181; H01M 6/40; H01M 10/0436; H01M 10/0585; H01M 6/22; H01M 2300/0082; H01M 2300/0085
USPC 429/124; 156/277

(57) ABSTRACT

A printed flexible battery is provided. The battery has an anode and a cathode printed on flexible, fibrous substrates. Current collectors are provided that form the anode/cathode connections when the assembly is folded. A hydrophobic polymer is printed in a pattern that contains the electrolyte to a predetermined region.

### CROSS-REFERENCE TO RELATED APPLICATIONS

This application is a non-provisional application of U.S. provisional Patent Application Ser. No. 61/806,533 (filed Mar. 29, 2013) the entirety of which is incorporated herein by reference.

### BACKGROUND OF THE INVENTION

The subject matter disclosed herein relates to printed electronics and to printed flexible batteries in particular.

Printed organic electronics have reached a level of maturity where electronics with sufficient performance can be manufactured. Organic electronics use an organic semiconductor as the semiconducting material. Due to the low mobility of organic semiconductors and large thickness of printed dielectrics, high voltage (10-30V) is required to power the device. Since most battery chemistries give cell voltages of less than 4V it is necessary to connect them in series in order to achieve the necessary voltages for powering printed electronic devices. Connecting multiple batteries in series while maintaining its form factors is non-trivial. Placing them side-by-side would increase the footprint of the battery and stacking them would make them non-compliant. An improved printed flexible battery is therefore desired.

The discussion above is merely provided for general background information and is not intended to be used as an aid in determining the scope of the claimed subject matter.

### BRIEF DESCRIPTION OF THE INVENTION

A printed flexible battery is provided. The battery has an anode and a cathode printed on one or more flexible, fibrous substrates. Current collectors are provided that form the anode/cathode connections when the assembly is folded. A hydrophobic polymer is printed in a pattern that confines the electrolyte to a predetermined region. An advantage that may be realized in the practice of some disclosed embodiments is that a flexible battery is provided that can power high voltage applications while still maintaining flexibility and a small footprint.

In a first embodiment, a printed flexible battery is provided. The battery comprises a flexible substrate, a first plurality of electrodes and a second plurality of electrodes. The first plurality of electrodes and the second plurality of electrodes are printed into the flexible substrate to a depth of less than 50% of the flexible substrate with each electrode connected in electrical series by electrically conductive current collectors printed on the plurality of electrodes.

In a second embodiment, a printed flexible battery is provided. The battery comprises a flexible substrate, a first plurality of electrodes and a second plurality of electrodes. The first plurality of electrodes and the second plurality of electrodes are printed into the flexible substrate to a depth of less than 50% of the flexible substrate. A hydrophobic polymer is printed on the flexible substrate between each electrode in the first plurality of electrodes. The first plurality of electrodes are stacked relative to the second plurality of electrodes to form a first layer and a second layer, respectively, with each electrode connected in electrical series by electrically conductive current collectors.

In a third embodiment, a method for forming a printed flexible battery is provided. The method comprises printing a first plurality of electrodes and a second plurality of electrodes onto a flexible substrate, the printing occurring to a depth of less than 50% of the flexible substrate. A hydrophobic polymer is printed onto the flexible substrate between each electrode in the first plurality of electrodes. Current collectors are printed on the electrodes of the first plurality of electrodes to form a first electrical series. Current collectors are printed on the electrodes of the second plurality of electrodes to form a second electrical series. The first plurality of electrodes are stacked relative to the second plurality of electrodes to electrically connect, in series, the first electrical series with the second electrical series in a stacked assembly. The stacked assembly is laminated in a packaging material to form a printed flexible battery.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is top view of one embodiment of a printed flexible assembly;

FIG. 2A, FIG. 2B and FIG. 2C are graphs illustrating the electrical characterization of a battery made by the disclosed method;

FIG. 3A is a schematic of a ring oscillator powered by a battery made by the disclosed method, FIG. 3B shows the voltage output from the ring oscillator when powered with a battery made by the disclosed method, while FIG. 3C depicts the voltage output from the oscillator and the battery;

FIG. 4 depicts an embodiment wherein a battery is formed by folding a single sheet;

FIG. 5A is a cross sectional view of an embodiment where a current collector is printed on a cathode which, in turn, was printed on a flexible fibrous substrate, while FIG. 5B is a cross sectional view of another embodiment where a current collector is printed on a support substrate; and

FIG. 6A is a top view of another embodiment of a printed flexible assembly showing an alternative while FIG. 6B is a cross sectional view of the printed flexible assembly of FIG. 6A.

### DETAILED DESCRIPTION OF THE INVENTION

This disclosure describes a method for fabricating a high voltage printed flexible battery by printing multiple cells on a substrate and then connecting the cells in series. Also disclosed is the product resulting from this method. Individual electrodes in the battery pack are separated by printed hydrophobic polymer ink. The high voltage printed battery can be used as a power source for compliant electronic devices that have high operating voltage (e.g. 10-30 V).

A low-cost, air-stable, flexible high-voltage (e.g. greater than 10 V) battery is provided. This is an important development, particularly for the powering of printed, flexible electronic devices. Typically, due to the resolution of a print process, low-mobility of low-temperature solution processed (less than 150° C.) semiconductors, and high thickness (typically greater than 300 nm) of the low k dielectrics that are often used, the driving voltages for flexible printed transistors and circuits made from them are at least 10V and most typically 15-20 V. Since most battery chemistries give cell voltages of less than 4V it is necessary to connect them in series in order to achieve the necessary voltages for powering printed electronic devices. However, making such a battery for this application creates a number of issues, which need to be resolved in order to create a useful solution. For a typical alkaline chemistry, the cell voltage is 1.5 V requiring about 10 cells to be connected in series to achieve a 15 V open circuit voltage for the completed battery. Stacking these cells on top of one another would preserve a small footprint but would create a very thick battery, which would no longer have the correct form factor or flexibility. Placing the cells adjacent to one another would retain flexibility, but would lead to a larger footprint.

The disclosed method fabricates multi-cell batteries directly rather than making fully formed batteries composed of single cells and connecting them together externally. Using a print process for manufacturing is beneficial as this readily allows the energy and power of the battery to be customized for the particular application. The disclosed methods also obviate the need to seal individual cells. The disclosed batteries are particular useful for use with thin printed circuits/sensors that require high voltage for proper operation, yet need a small footprint. Examples include RFID cards, smart labels, smart bank cards, the like. Various modes of printing are contemplated including, but not limited to digital printing using liquid ink printers, stencil printing, screen printing, gravure printing, inkjet printing, flexo printing, spray printing.

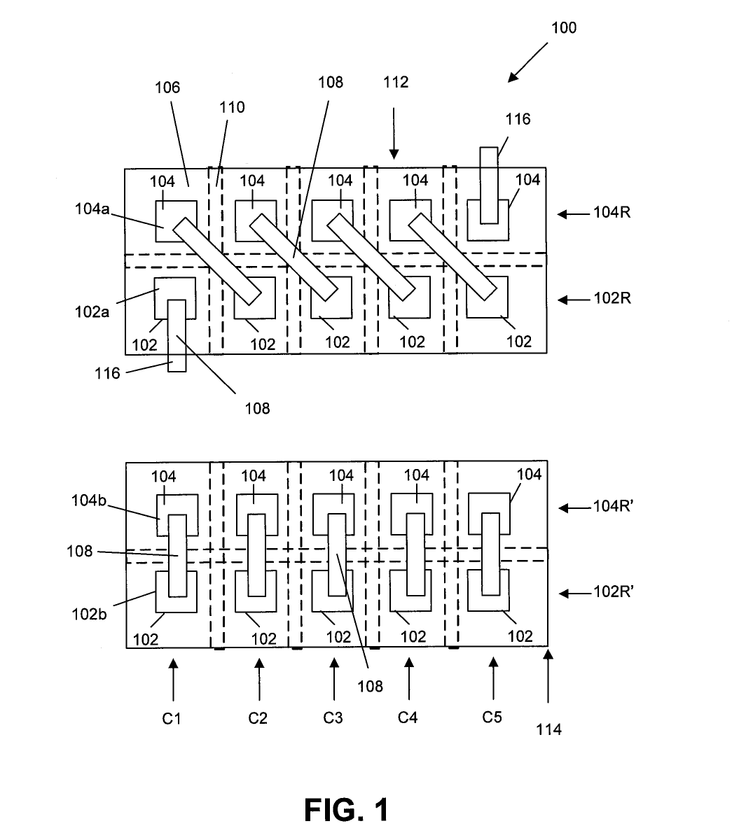

FIG. 1 is top view of one embodiment of a printed flexible assembly 100 fabricated through stencil printing of cathodes 102 (e.g. Zn) and anodes 104 (e.g. MnO₂) onto one or more flexible fibrous substrates 106 (e.g. cellulose fiber substrates, polyimide and polyvinyl alcohol). The cathode 102 and the anode 104 are printed next to one another and in such a way that the electrode material does not fully penetrate the flexible fibrous substrates 106. A current collector 108 (e.g. silver ink) is printed in such a way to cover the cathodes 102 and anodes 104, as to make series connections between them. In one embodiment, the surface of the electrodes is covered with a relatively large surface area pad of the current collector while the interconnect between adjacent electrodes is provided by a relatively small surface area ribbon of the current collector. A hydrophobic polymer 110 (e.g. a perfluoropolymer such as these sold under the brand names TEFLON® or CYTOP®) is printed between the cells in order to prevent migration of the electrolyte in the completed battery. Two separate substrates 112 and 114 are formed this way, which will then be stacked and laminated together to make the final battery. For example, the cathode 102a is stacked with the anode 104b such that their respective current collectors 108 contact. Likewise, the anode 104a is stacked with the cathode 102b such that their respective current collectors 108 contact. The cathodes 102 are arranged in cathode rows 102R, 102R′ while the anodes 104 are arranged in anode rows 104R, 104R′. In the embodiment of FIG. 1, each column (C1, C2, C3, C4 and C5) has one cathode and one anode. In substrate 112, the current collectors 108 connect a cathode 102 with a corresponding anode 104 in an adjacent column. Electrically conductive tabs 116 (e.g. nickel tabs) function as current collectors that provide an external electrical connection. In substrate 114, the current collectors 108 connect a cathode 102 with a corresponding anode 104 in the same column. After stacking, the printed flexible assembly 100 is then heat-sealed in a package to provide a printed flexible battery.

Each cell provides a predetermined voltage (e.g. 1.5 V). In the embodiment of FIG. 1, ten cells are connected in series to provide a predetermined total voltage (e.g. 15V). In other embodiments, additional or fewer cells are provided to change the predetermined total voltage for a particular application.

Points to note about this exemplary fabrication method include the printing of the electrodes so they do not fully penetrate the flexible fibrous substrates 106. This prevents the anodes from coming into contact with the cathodes and shorting the battery. This allows the battery to be made without the need of a separator layer to prevent shorting, thereby making the battery thinner and improving mechanical flexibility. Also, the addition of the printed hydrophobic polymer wells prevents electrolyte from migration between cells, which would reduce the batteries voltage. The hydrophobic polymer wells also allow smaller spacing between cells, enabling a battery with a smaller footprint to be made. The fabrication process can be performed using a roll-to-roll process, which simplifies production.

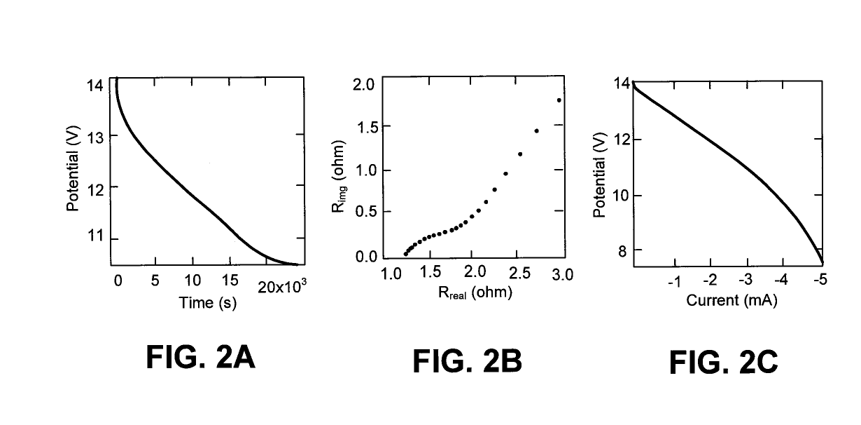

FIG. 2A, FIG. 2B and FIG. 2C illustrate the electrical characterization of a battery made by this disclosed method. These figures indicate that high voltages can be produced while maintaining low impedance, allowing levels of current necessary to power printed electronic devices. FIG. 2A shows a discharge curve of the battery, discharged by connecting across a 100,000-ohm resistor. FIG. 2B depicts a typical EIS curve of an individual cell at frequency ranging from 100,000 to 10 Hz at amplitude of 10 mV. FIG. 2C shows a polarization curve of the battery at scan rate of 50 mV per second.

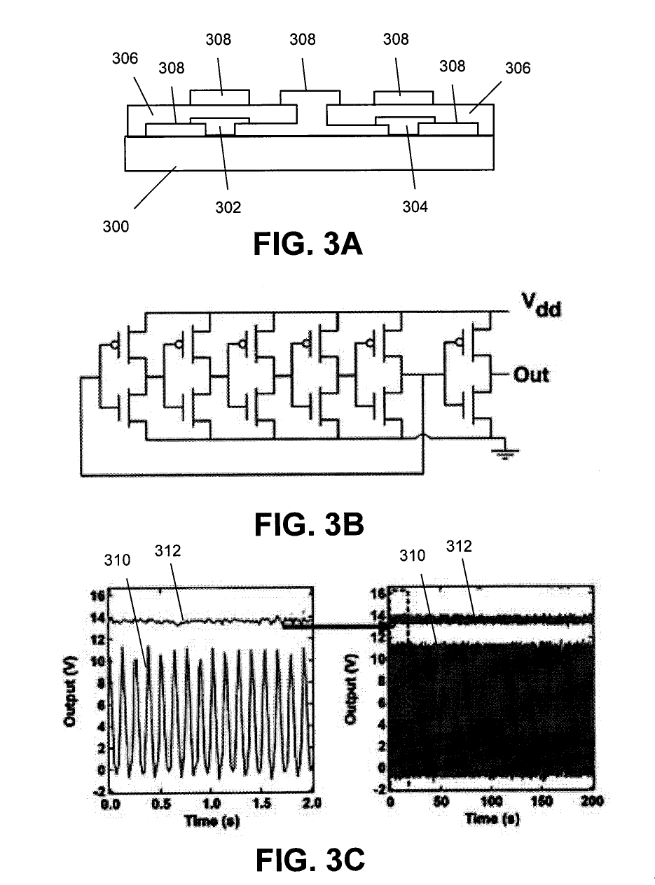

As shown in FIG. 3A, FIG. 3B and FIG. 3C, the batteries made by the disclosed methods have been demonstrated to be capable of powering a flexible printed circuit by using the battery to drive a ring oscillator. Over the course of this experiment (about 15 minutes) no change in the battery voltage was observed (as would be expected when powering a low current devices such as the printed ring oscillator). FIG. 3A is a schematic of the ring oscillator with a PEN substrate 300, n-semiconductor 302, p-semiconductor 304, dielectric 308 and silver metallization 308. FIG. 3B is a circuit diagram of the five-stage ring oscillator. FIG. 3C is the voltage output from the five-stage ring oscillator when powered with a 12V printed battery made by the disclosed method. FIG. 3C depicts the voltage output 310 from the oscillator and the voltage output 312 from the battery.

At least some embodiments provide at least one of the following advantages: (1) a high voltage flexible battery formation through lamination of two flexible substrates of printed anode and cathode with the current collector used to make series connections (2) use of a printed hydrophobic separator to prevent migration of electrolyte between cells (3) printing the layers so that they do not completely penetrate the substrate allows the battery to be made without the need of a separate separator layer—improving device flexibility (4) use of a fibrous membrane as the substrate, which absorbs electrolyte readily and gives a good mechanical support to the printed anode and cathode (5) prevents the need of sealing individual cells in the battery pack (6) the patterning and connection of individual cells in the battery pack.

Examples of suitable cathodes include Zn, LiFePO₄, LiCoO₂ and LiMn₂O₄. Examples of suitable anodes include MnO₂, graphite and Li₄Ti₅O₁₂. Examples of suitable current collectors include conductive links, silver, nickel, conductive carbon, carbon nanotubes and copper. Examples of suitable flexible fibrous substrates include PEN, PET, polypropylene, polyethylene and an aluminum-laminated battery pouch. The flexible fibrous substrate may be relatively thin, for example, 100 microns or less. The electrodes are printed to be 50 to 150 microns thick but only partially extend into the flexible fibrous substrate, for example, by 50% or less of the substrate's thickness. In one embodiment, the electrodes extend by about 30% of the substrate's thickness. For example, the fibrous substrate may be 100 microns thick, the electrodes may be 50-150 microns thick, and about 30 microns of the electrode's thickness is embedded in the fibrous substrate. The current collector is printed in a relatively thin layer, for example, 2-5 microns thick.

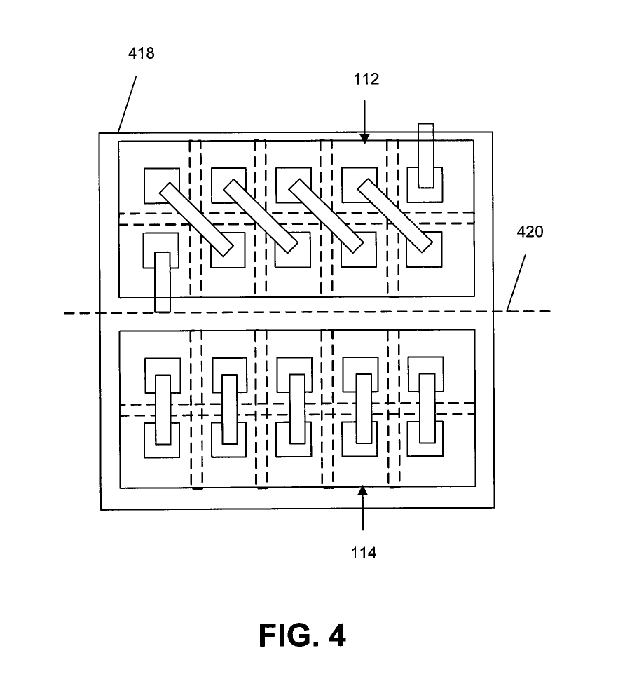

FIG. 4 depicts an embodiment wherein both sheets 112 and 114 are printed on a single support substrate 418. Such an embodiment permits both sheets 112 and 114 to be simultaneously printed in a single operation, which streamlines fabrication and increases the accuracy with which the components can be positioned relative to one another. After printing, the assembly is folded along fold line 420. When the support substrate 418 is a polymeric support substrate, the assembly can be laminated to melt the support substrate and seal the resulting battery. The support substrate 418 may be, for example, plastic or an aluminum-laminated pouch.

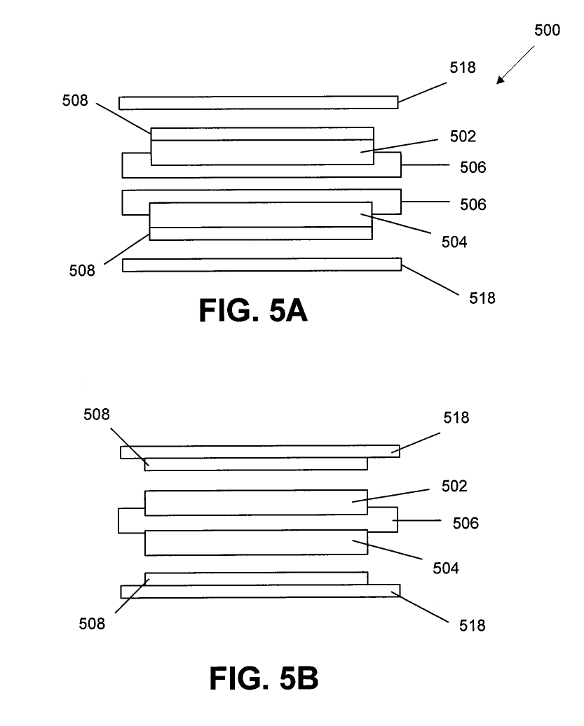

FIG. 5A is a cross sectional view of an embodiment where a current collector 508 is printed on a cathode 502 which, in turn, was printed on a flexible fibrous substrate 506. Likewise, a current collector 508 is printed on an anode 504 which, in turn, was printed on a second flexible fibrous substrate 506. A support substrate 518 is provided that, after lamination, forms packaging for the assembled battery.

FIG. 5B is a cross sectional view of another embodiment where a current collector 508 is printed on a support substrate 518. During stacking and subsequent lamination a cathode 502 and an anode 504, both of which are printed on a flexible fibrous substrate 506, are aligned with the current collectors 508 to form the assembled battery.

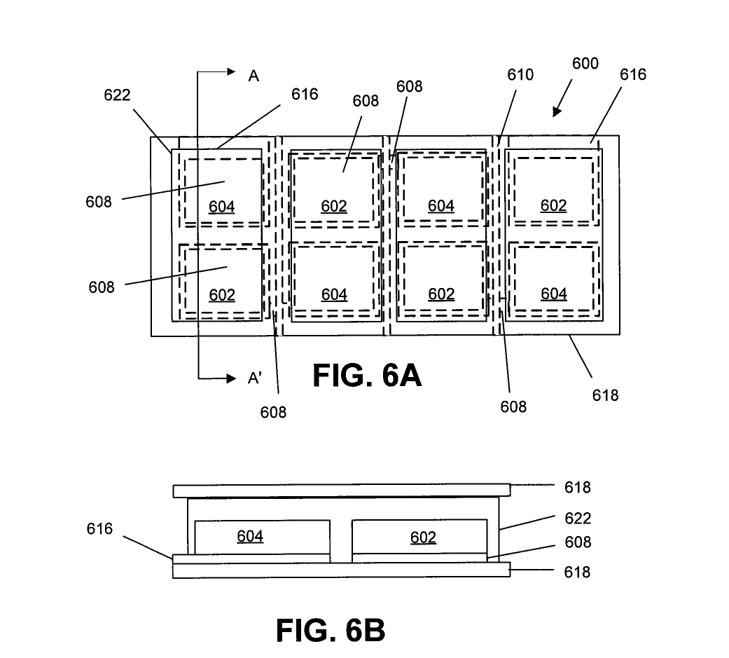

FIG. 6A is a top view of another embodiment of a printed flexible assembly 600 that comprises cathodes 602, anodes 604, both of which are printed on a flexible support substrate 618. Current collectors 608 provide interconnections between a cathode 602 and an adjacent anode 604, both of which are in the same row. The current collectors 608 are present as enlarged pads that cover each electrode and as narrow ribbons that connect adjacent electrodes. The ribbons are staggered between the first row and the second row to provide an alternative connection between anodes 604 and cathodes 602, which are also staggered within a given row. A polymer gel electrolyte 622 (e.g. polyethylene oxide or polyacrylic acid) electrically connects each cathode of a first row to a corresponding anode in a second row, where both electrodes are in the same column. A hydrophobic polymer 610 is printed on the flexible support substrate 618 such that the hydrophobic polymer separates adjacent electrodes. Two tabs 616 provide external electrical connections. In the embodiment of FIG. 6A, four cells are illustrated. If each cell were, for example, a 1.5V cell, then four cells would provide a predetermined total voltage of 6V. FIG. 6B is a cross sectional view of the printed flexible assembly 600 along line A-A′ of FIG. 6A.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A printed flexible battery comprising:
a flexible substrate;
a first plurality of electrodes and a second plurality of electrodes, wherein the first plurality of electrodes and the second plurality of electrodes are printed into the flexible substrate to a depth of less than 50% of a thickness of the flexible substrate, wherein each electrode is connected in electrical series by electrically conductive current collectors printed on the plurality of electrodes.

2. The printed flexible battery as recited in claim 1, wherein the first plurality of electrodes are in the same plane as the second plurality of electrodes, the printed flexible battery further comprising a plurality of polymer gel electrolytes, each providing electrical connection between one electrode in the first plurality of electrodes and a corresponding electrode in the second plurality of electrodes.

3. The printed flexible battery as recited in claim 2, wherein the electrically conductive current collectors comprise both metallic current collectors and polymer gel current collectors.

4. The printed flexible battery as recited in claim 1, wherein the thickness of the flexible substrate is less than 100 microns.

5. The printed flexible battery as recited in claim 1, wherein the flexible substrate is selected from the group consisting of polyimide and polyvinyl alcohol.

6. The printed flexible battery as recited in claim 1, wherein the flexible substrate is a cellulose fiber substrate.

7. The printed flexible battery as recited in claim 1, further comprising a hydrophobic polymer printed on the flexible substrate between each electrode in the first plurality of electrodes.

8. The printed flexible battery as recited in claim 1, wherein the first plurality of electrodes are stacked relative to the second plurality of electrodes to form a first layer and a second layer, respectively.

9. The printed flexible battery as recited in claim 8, wherein the flexible substrate is a single sheet and the first layer and the second layer are formed by folding the single sheet across a fold line.

10. The printed flexible battery as recited in claim 8, wherein the flexible substrate comprises a first flexible substrate comprising the first plurality of electrodes and a second flexible substrate comprising the second plurality of electrodes and the first layer and the second layer are formed by stacking the first flexible substrate with the second flexible substrate.

11. The printed flexible battery as recited in claim 8, further comprising packaging material, wherein the first plurality of electrodes and the second plurality of electrodes are sealed within the packaging material such that at least two electrically conductive tabs extend through the packaging material to permit an electrical connection to outside of the packaging material.

12. A printed flexible battery comprising:
a flexible substrate;
a first plurality of electrodes and a second plurality of electrodes, wherein the first plurality of electrodes and the second plurality of electrodes are printed into the flexible substrate to a depth of less than 50% of a thickness of the flexible substrate;
a hydrophobic polymer printed on the flexible substrate between each electrode in the first plurality of electrodes; and
wherein the first plurality of electrodes are stacked relative to the second plurality of electrodes to form a first layer and a second layer, respectively, each electrode connected in electrical series by electrically conductive current collectors.

13. The printed flexible battery as recited in claim 12, wherein the hydrophobic polymer is printed between each electrode in the second plurality of electrodes.

14. The printed flexible battery as recited in claim 13, wherein the hydrophobic polymer is a perfluoropolymer.

15. The printed flexible battery as recited in claim 13, wherein the flexible substrate comprises a first flexible substrate comprising the first plurality of electrodes and a second flexible substrate comprising the second plurality of electrodes.

16. The printed flexible battery as recited in claim 13, wherein the first plurality of electrodes comprise a first anode row comprising only anodes and into a first cathode row comprising only cathodes.

17. The printed flexible battery as recited in claim 16, wherein the second plurality of electrodes comprise a second anode row comprising only anodes and into a second cathode row comprising only cathodes.

18. The printed flexible battery as recited in claim 13, wherein the first plurality of electrodes comprise a first row comprising alternating anodes and cathodes such that each anode in the first row is adjacent at least one cathode in the first row.

19. The printed flexible battery as recited in claim 18, wherein the second plurality of electrodes comprise a second row comprising alternating anodes and cathodes such that each anode in the second row is adjacent at least one cathode in the second row.

20. A method for forming a printed flexible battery, the method comprising:
printing a first plurality of electrodes and a second plurality of electrodes onto a flexible substrate, the printing occurring to a depth of less than 50% of a thickness of the flexible substrate;
printing a hydrophobic polymer onto the flexible substrate between each electrode in the first plurality of electrodes;
printing current collectors on the electrodes of the first plurality of electrodes to form a first electrical series;
printing current collectors on the electrodes of the second plurality of electrodes to form a second electrical series;
stacking the first plurality of electrodes relative to the second plurality of electrodes to electrically connect, in series, the first electrical series with the second electrical series in a stacked assembly; and
laminating the stacked assembly in a packaging material to form a printed flexible battery.
